(19) United States
(12) Patent Application Publication
(10) Pub. No.: US 2009/0183070 A1
(43) Pub. Date: Jul. 16, 2009

(54) MULTIMODAL COMMUNICATION AND COMMAND CONTROL SYSTEMS AND RELATED METHODS

(76) Inventor: David Robbins, Natick, MA (US)

Correspondence Address: WEINGARTEN, SCHURGIN, GAGNEBIN & LEBOVICI LLP, TEN POST OFFICE SQUARE, BOSTON, MA, 02109, US

(21) Appl. No.: 12/300,165

(22) PCT Filed: May 11, 2007
(86) PCT No.: PCT/US2007/011476

§ 371 Date: Nov. 10, 2008

Related U.S. Application Data
(60) Provisional application No. 60/747,026, filed on May 11, 2006.

(51) Int. Cl. G06F 3/00; G06F 3/01; G06F 15/18

(52) U.S. Cl. 715/702; 710/5; 706/12; 710/19; 700/94; 715/727; 704/275

(57) ABSTRACT

Systems and methods are provided that enable multimodal communication command and control of various systems, such as the Internet, cable or satellite television, and other systems, with utilization of a device configured to accept user command and control inputs and an interface to the system or systems being controlled.

### RELATED APPLICATIONS

The present disclosure claims the benefit of U.S. Provisional Application No. 60/747,026 filed May 11, 2006, the contents of which application are incorporated by reference herein in its entirety.

### BACKGROUND

The command and control market is at a crossroads. Consumers are integrating more devices into their entertainment systems (e.g., DVD burners, networked media, Hi-Def DVD, etc.) each of which has its own remote control. These new digital sources—coupled with internet content such as available on YouTube and iTunes Web sites—is enticing consumers with vast media libraries of hundreds of thousands of titles. At the same time the user wants a simple control device that fits in the hand as the user relaxes in their home. This is driving a conflict into the command and control space: greater interactivity and control demanded from a handheld device. There are two ways to address this challenge—through menus and screens, or through voice control.

The menu-based approach is complex to program and its requirement to traverse screens to achieve a result can be confusing and inconvenient. It makes the user chose between many simple screens or a single very complex screen. This approach hit its vogue with the Pronto but has fallen to the streamlined approach of the Harmony which has an array of buttons and a small screen for simple commands.

Voice control has the advantage of being the most common means of interaction known to human beings. Through voice a user can navigate directly to the artist, song, movie, or function that she/he is seeking. In the button world this would require tens or even hundreds of button presses (e.g., paging through thousands of music albums five at a time). Limitations of voice control can arise when common or repeated actions are required, such as channel control or volume.

A common problem with conventional universal remotes is their frequent failure to properly deliver the desired command (due to delay in component responsiveness) or for the wrong command to be sent (due to inaccurate programming). It is also common for users to employ both a universal remote control and the original remote that came with the component within a window of time, confusing universal remotes that send commands based on the last known state of the components. This issue can arise from the pervasive use in the consumer electronics industry of Toggle IR Codes in which the component alternates between two states (like on and off) when it receives a certain command. These codes are in contrast to the less common Discrete IR codes which use a different IR command string to indicate each command. We can consider the example in which a universal remote is used to turn off the users systems, then later another user in the home turns on the cable box and doesn't turn it off afterwards. The universal remote control will expect that the cable box is turned off and will send the command to turn on the cable box, but since this power command is a toggle code the cable box turns off instead of on, confusing the user and requiring a multi-step debugging process to fix the problem.

### SUMMARY

The present disclosure addresses the limitations noted previously for the prior art. Embodiments of the present disclosure can be utilized for multimodal communication command and control of various types of systems having features/components that are remote from or difficult/undesirable to access by a user. For such command and/or control, suitable wireless techniques can be utilized by a user input device that is configured and arranged to control one or more remote systems. Such wireless techniques can include but are not limited to those adapted to suitable RF standards (e.g., IEEE 802.11) or infrared (IR) transmission. Exemplary embodiments and/or aspects of the present disclosure can provide dedicated controls for volume, channel, and a multiple-way navigation button (e.g., five-way) for use by the user, e.g., in guides or on-screen menus.

Numerous types of systems can accordingly be controlled by way of one or more of multiple modes of communication, for example, home entertainment and media management systems, home and/or office and/or industrial automation systems (e.g., which can include lighting, alarm, and HVAC, and the like), computer, telephony, gaming systems, and devices accessing the Internet.

The multiple modes of interaction may include one or more of voice, speech, buttons, tactile response pads, graphical display, monitor or television display, and computer output device. For example, a user may ask a question of the system, which would process the request and respond by emitting an audible sound (like a tone, music, or speech), and concurrently display content on the user interface device and/or the television and/or the computer monitor. These listed modes are not exclusive and other modes of interaction/communication may also be utilized within the scope of the present disclosure.

Using such systems and methods of the present disclosure, a user can, for example, retrieve content from entertainment systems (e.g., “get me a Clint Eastwood movie”), command entertainment systems (e.g., “turn off the home theater”) and personal information managers (e.g., “what's my schedule for today?”), and the Internet (e.g., what will my weather be tomorrow?”), and control home and/or industrial and/or service automation systems (e.g., “turn off the lights.”). The system may comprise functionality for offering telephony services over the Internet (e.g., “call grandma”) and can respond accordingly, e.g., by looking up the appropriate number, dialing it, and facilitating the call over the Internet via voice over IP).

Embodiments of a system according to the present disclosure can include three units: (i) a wireless handheld communications device (e.g., the “Wand”); (ii) a communications broker or agent (e.g., the “Brain”); and (iii) a high-power processor (e.g the Server). In exemplary embodiments, the system can comprise a processor, repeater (or relay) for use with the user input device. The user input device can communicate instructions to the processor (which can reside in the Brain or on a separate Server). The Brain can be configured and arranged to process the instructions and in turn communicate to the system(s) being controlled (e.g., cable box, PC, Internet, etc.). Optionally, the Server can perform these tasks and communicate the appropriate actions to the Brain, which then communicates to the system(s) being controlled (e.g., cable box, PC, etc.). In exemplary embodiments, the user input/interface device can be configured as or reside in a mobile phone (e.g., cell or portable phone), landline phone PDA, or other connected mobile device. One or more servers may also be utilized in certain embodiments, and may be used in thin/thick client configurations as desired.

Exemplary embodiments of the present disclosure can provide for visual monitoring functionality or feedback of the state of the system(s) to be controlled. Accordingly, such functionality can ensure that commands to or requests of the system(s) have occurred or verify that the commands and/or request still need to occur (i.e., that the result intended by the user has not occurred yet).

### BRIEF DESCRIPTION OF THE DRAWINGS

Aspects of the disclosure may be more fully understood from the following description when read together with the accompanying drawings, which are to be regarded as illustrative in nature, and not as limiting. The drawings are not necessarily to scale, emphasis instead being placed on the principles of the disclosure. In the drawings, also referred to as diagrams:

FIG. 1 depicts an embodiment of a Server Process according to the present disclosure;

FIG. 2 depicts an embodiment of a Process Engine according to the present disclosure;

FIG. 3 depicts example of the State Matrix according to the present disclosure;

FIG. 4 depicts example of the Rules Matrix according to the present disclosure;

FIG. 5 depicts a Ramification Tables for the Brain, Wand, and Server in accordance with exemplary embodiments;

FIG. 6 depicts the System Architecture according to an embodiment of the present disclosure;

FIG. 7 depicts the Setup User [Experience] according to an embodiment of the present disclosure;

FIG. 8 depicts the Setup Process [Example] according to an embodiment of the present disclosure;

FIG. 9 depicts the Datastores used by a system in accordance with an embodiment;

FIG. 10 depicts the Watcher Process, Step 1 in accordance with an embodiment;

FIG. 11 depicts the Watcher Process, Step 2 in accordance with an embodiment according to FIG. 10;

FIG. 12 depicts example 1 of a system reference [image] according to an embodiment of the present disclosure;

FIG. 13 depicts example 2 of a system reference [image] according to an embodiment of the present disclosure;

FIG. 14 depicts example 3 of a system reference [image] according to an embodiment of the present disclosure;

FIG. 15 depicts the Watcher Reference Image Creation [Process] according to an embodiment of the present disclosure;

FIG. 16 depicts the Watcher Setup Verification Process according to an embodiment of the present disclosure;

FIG. 17 depicts the Watcher Command Verification [Process] according to an embodiment of the present disclosure;

FIG. 18 depicts the Wand according to an embodiment of the present disclosure;

FIG. 19 depicts the Wand Components according to an embodiment of the present disclosure;

FIG. 20 depicts the Brain and Extender according to an embodiment of the present disclosure;

FIG. 21 depicts the Brain Components, Low Power Version according to an embodiment of the present disclosure;

FIG. 22 depicts the Brain Components, High Power Version according to an embodiment of the present disclosure; and

FIG. 23 depicts a Watcher according to an embodiment of the present disclosure.

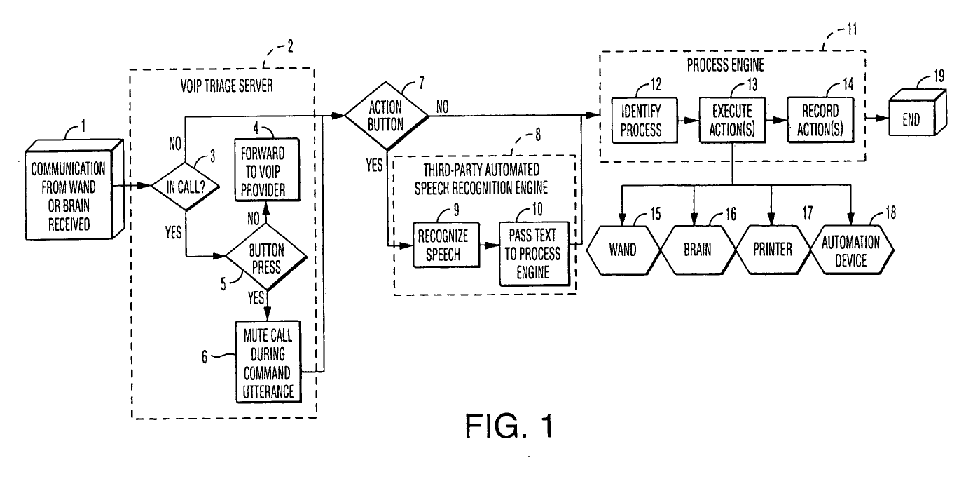

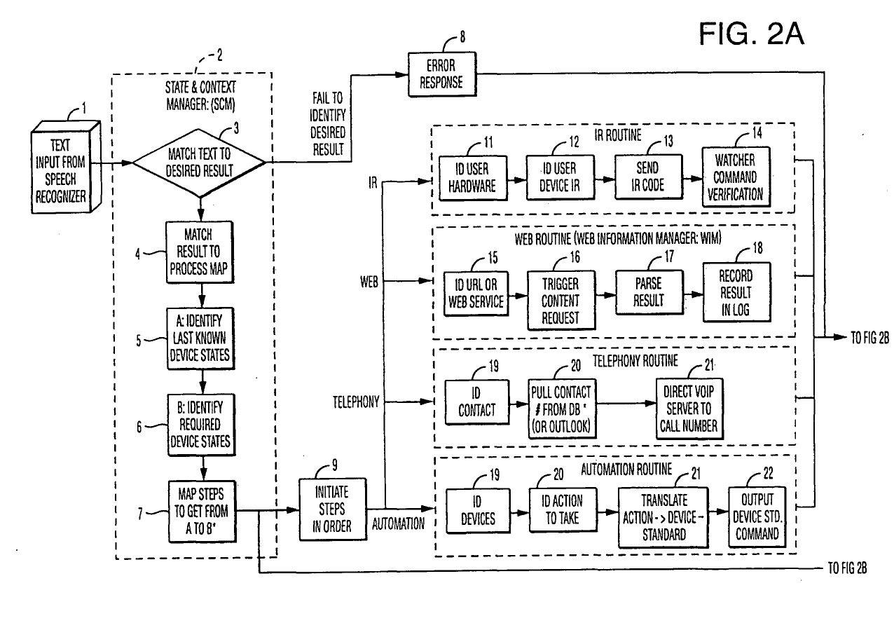

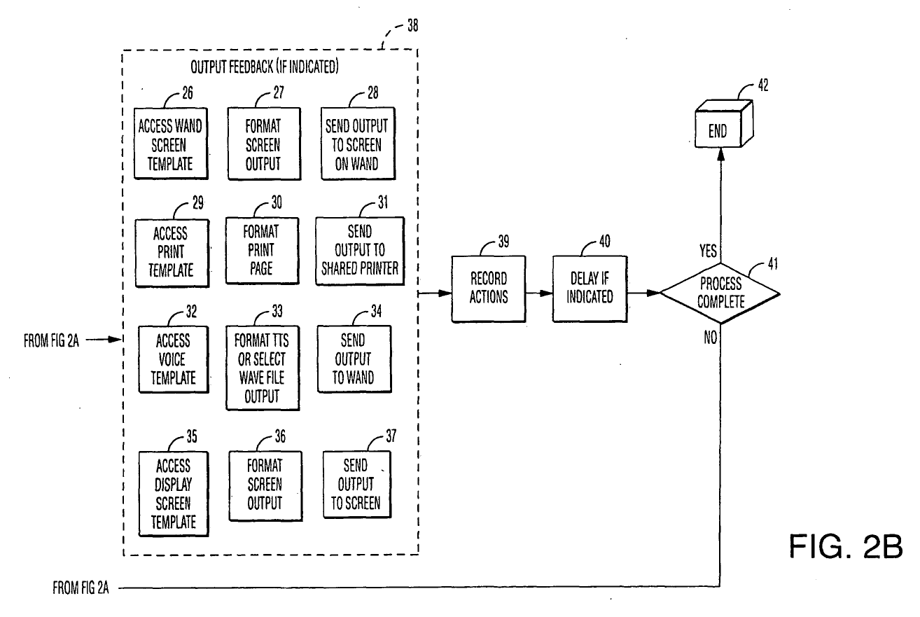

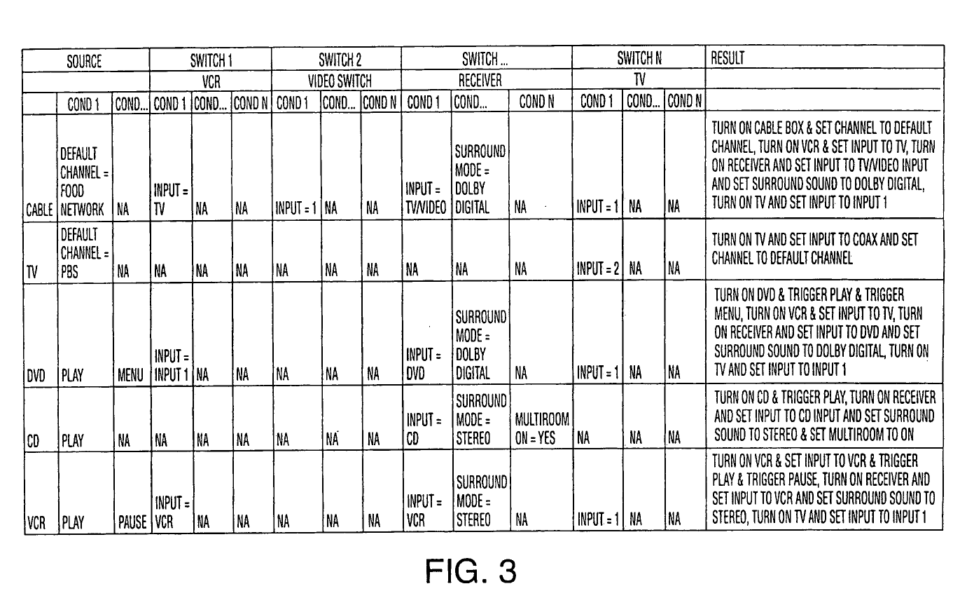

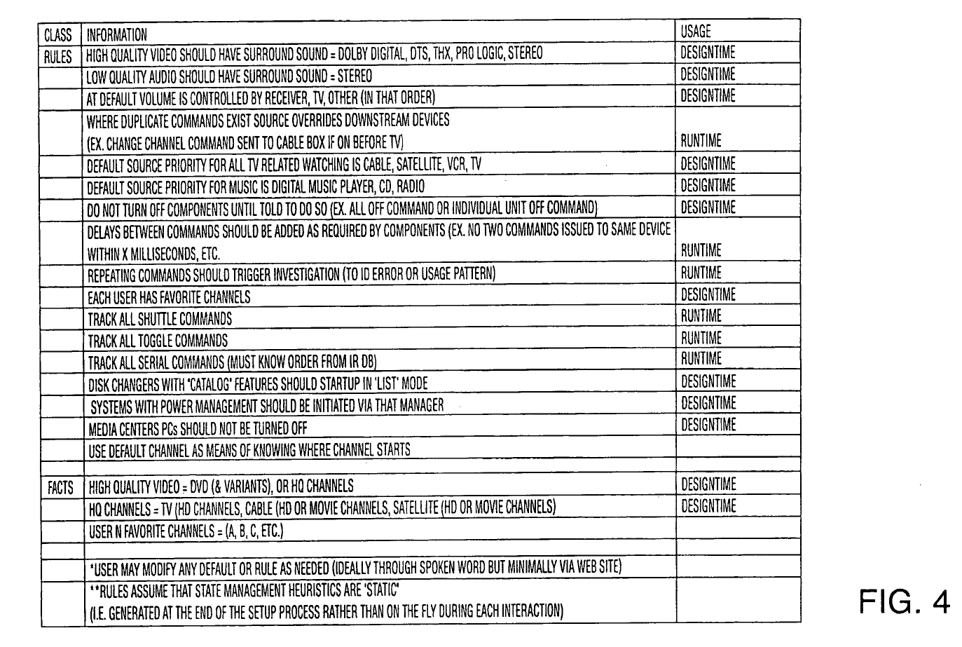

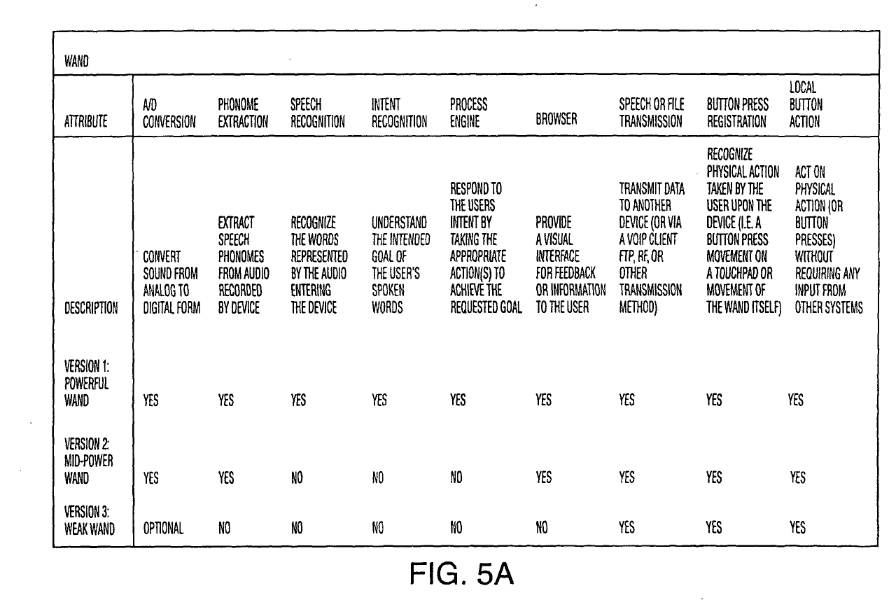

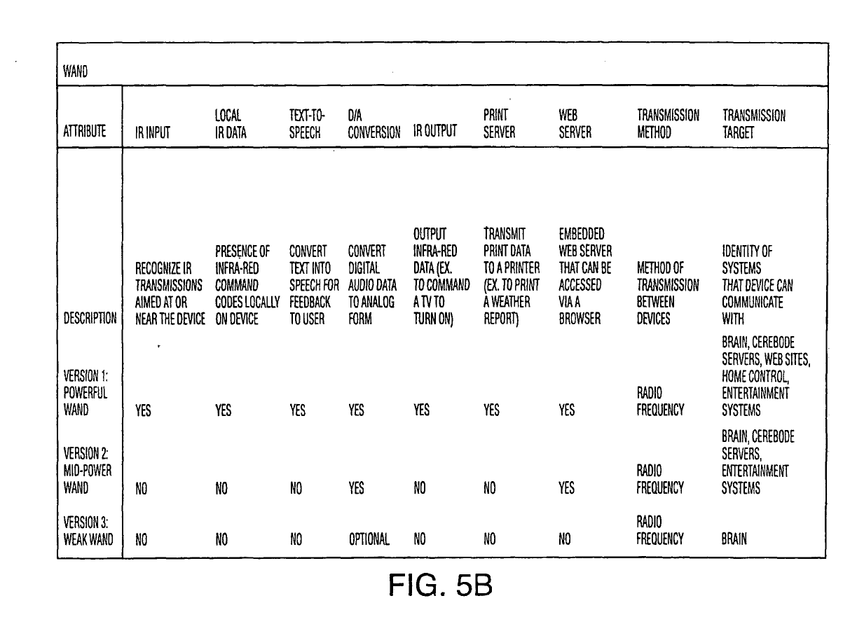

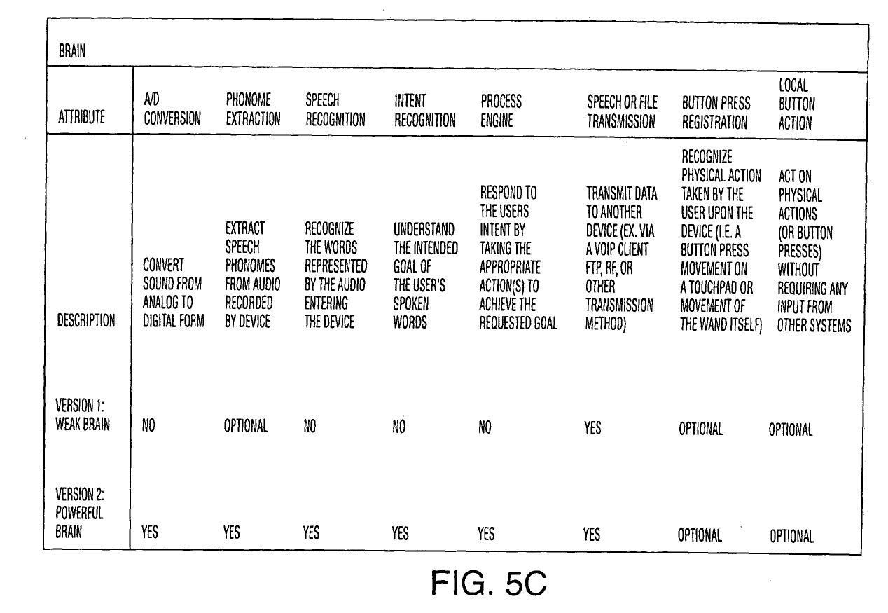

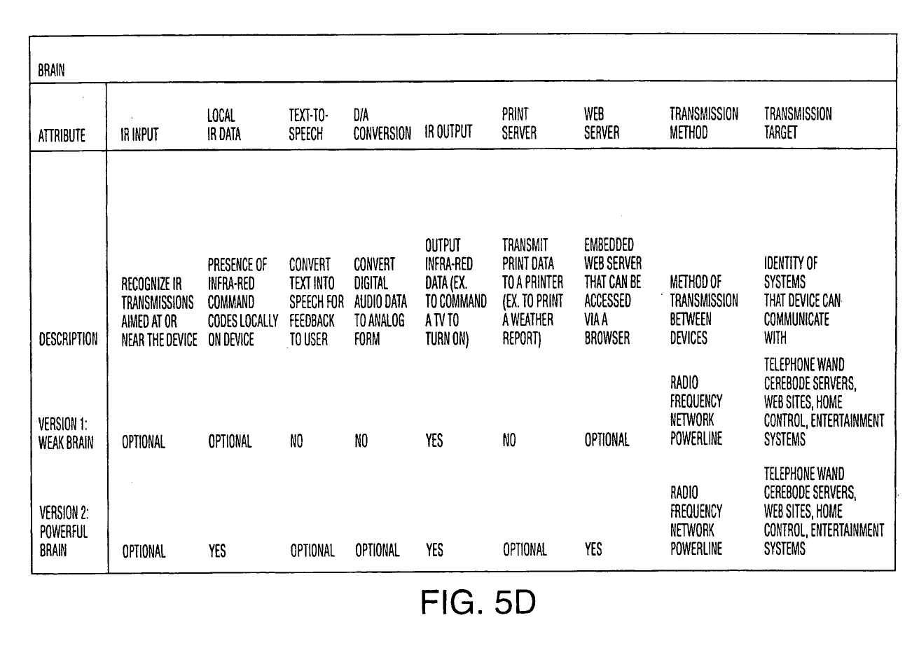

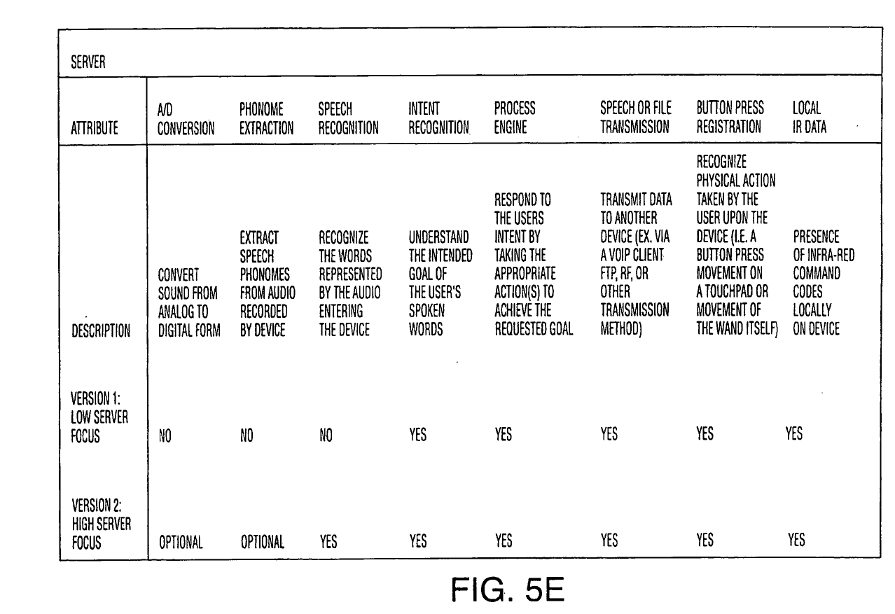

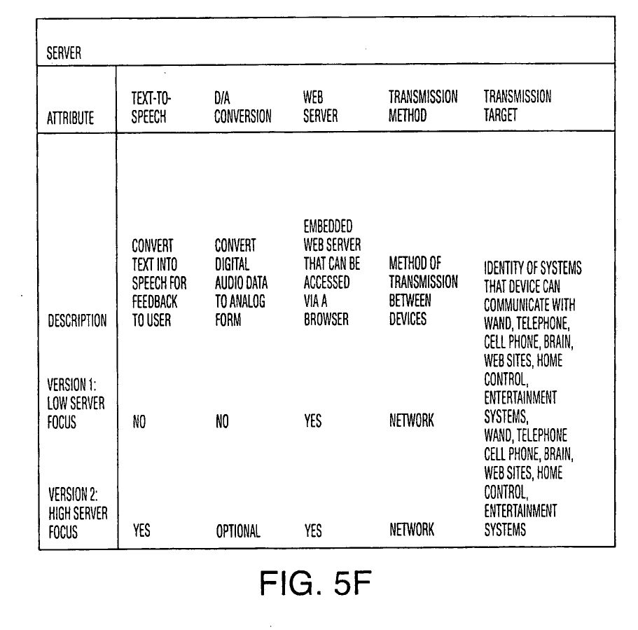

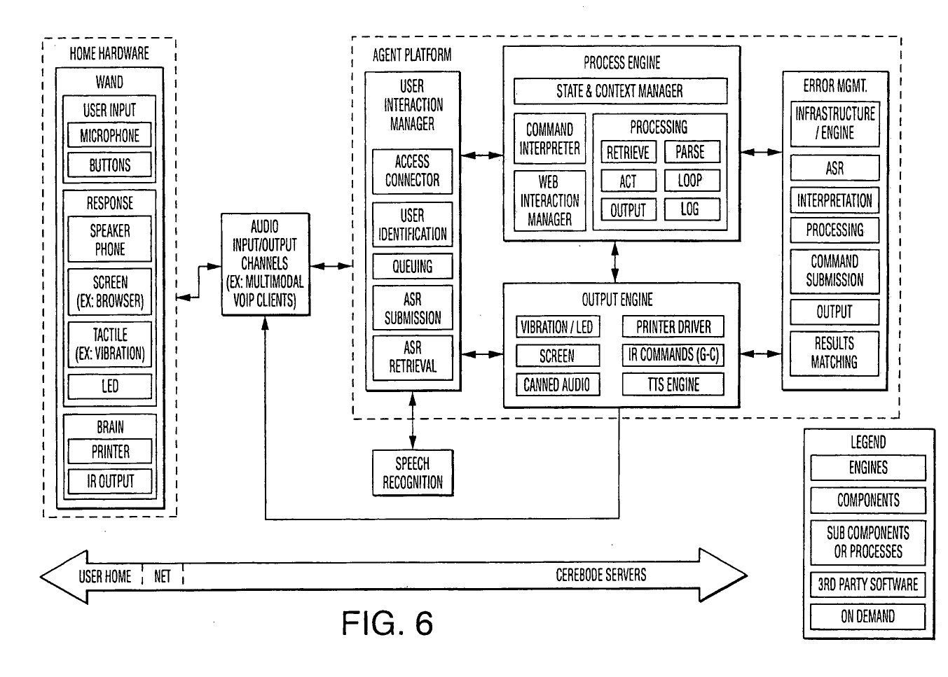

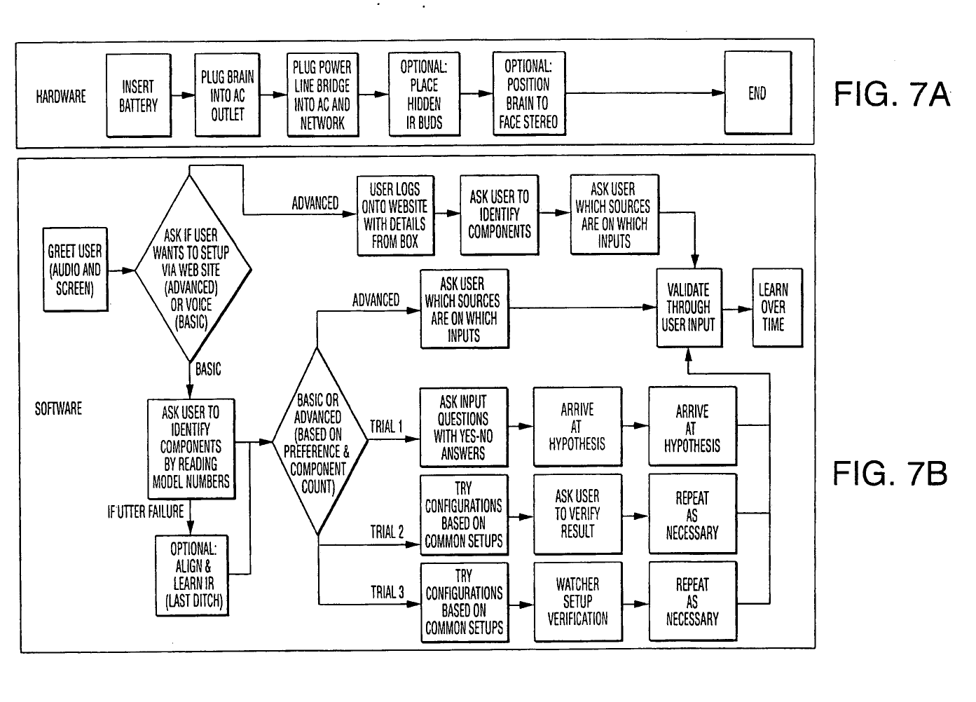

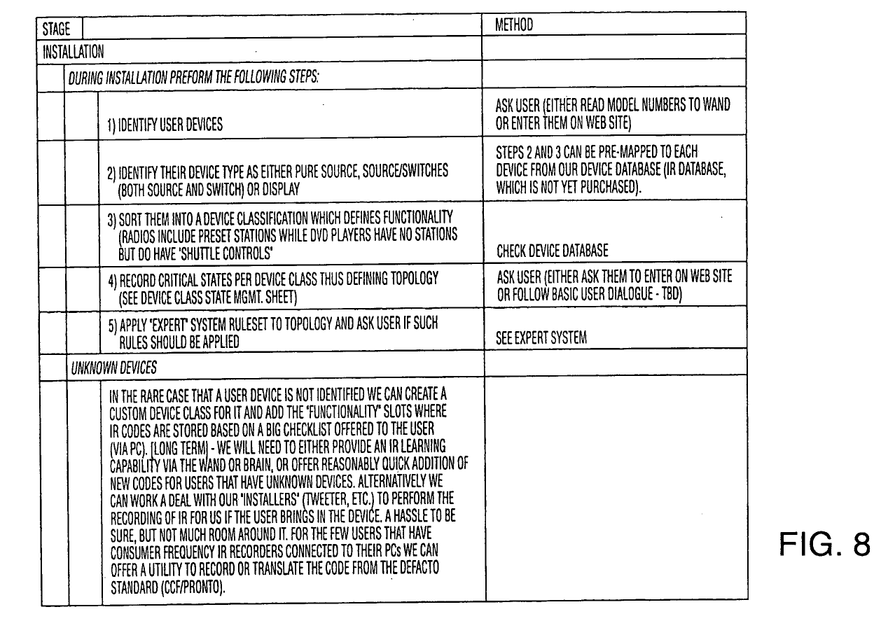

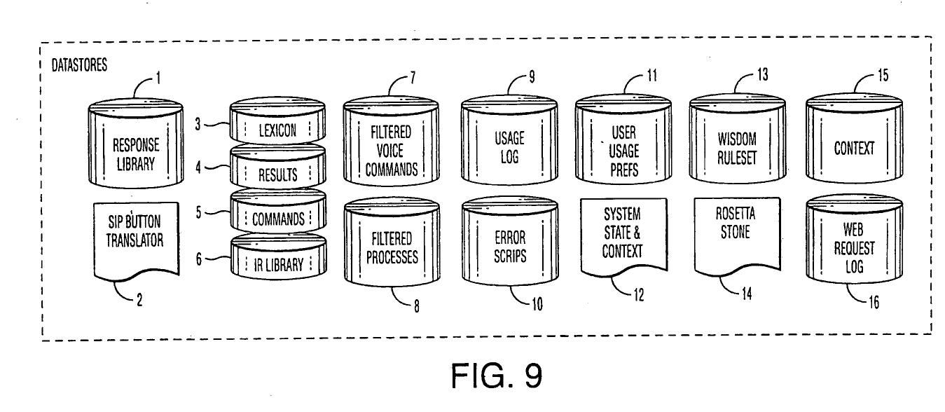

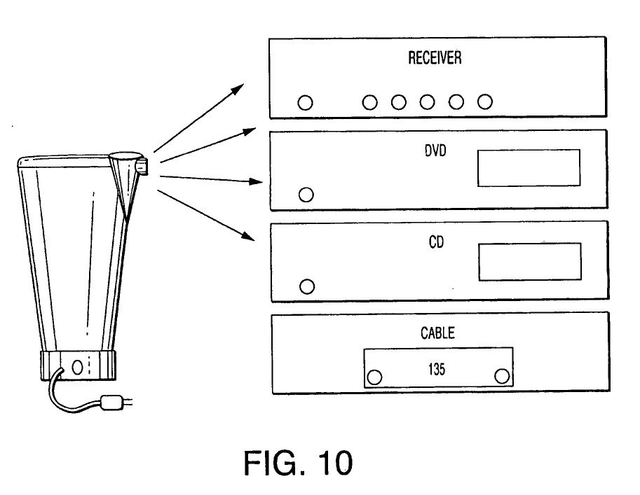

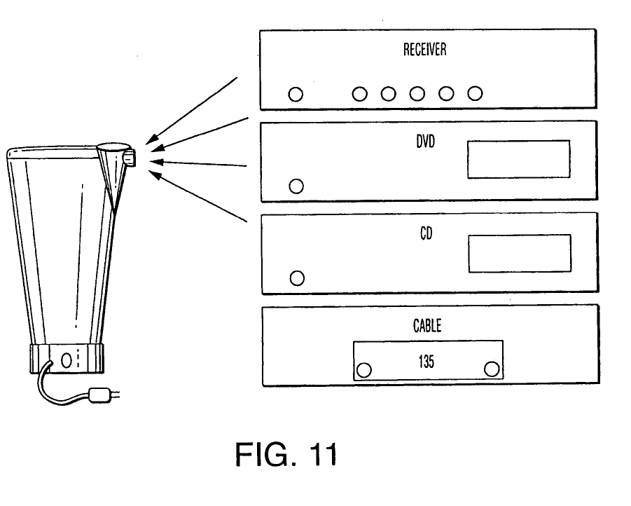

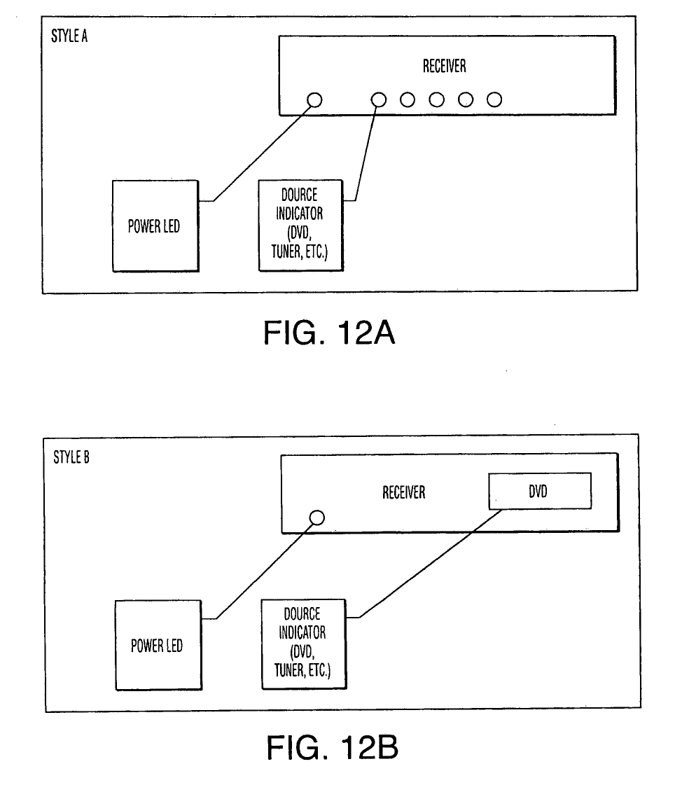

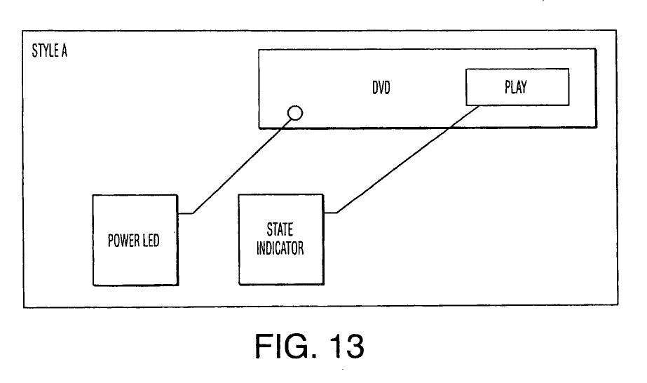

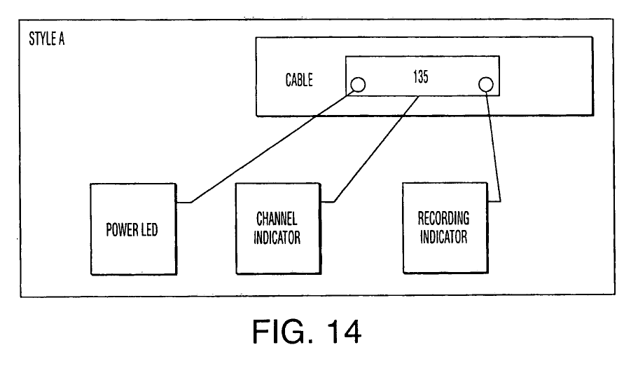

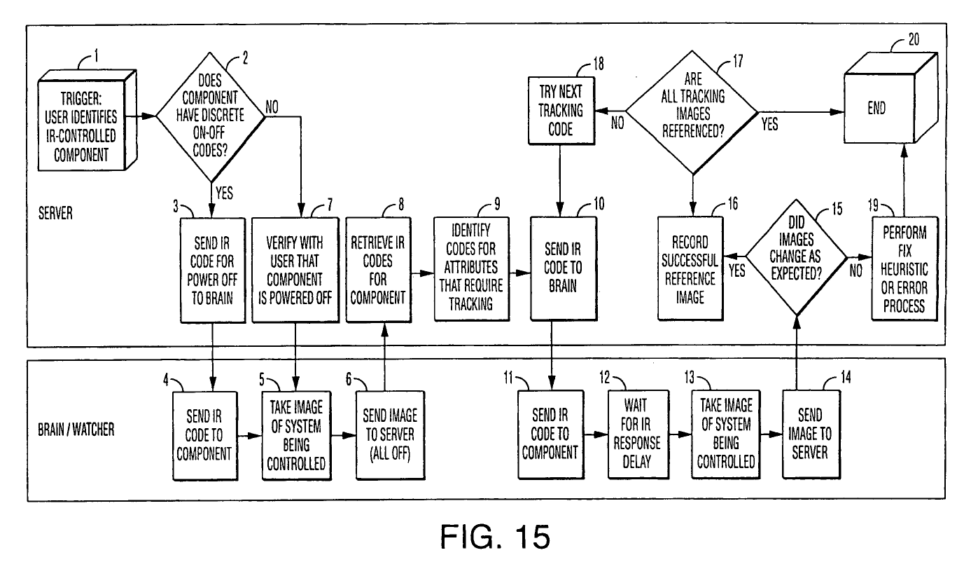

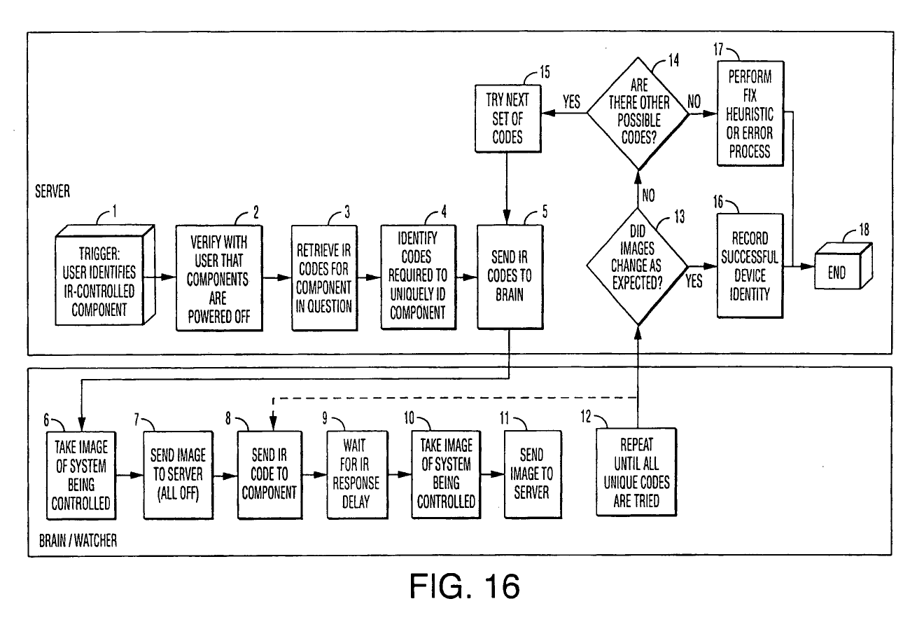

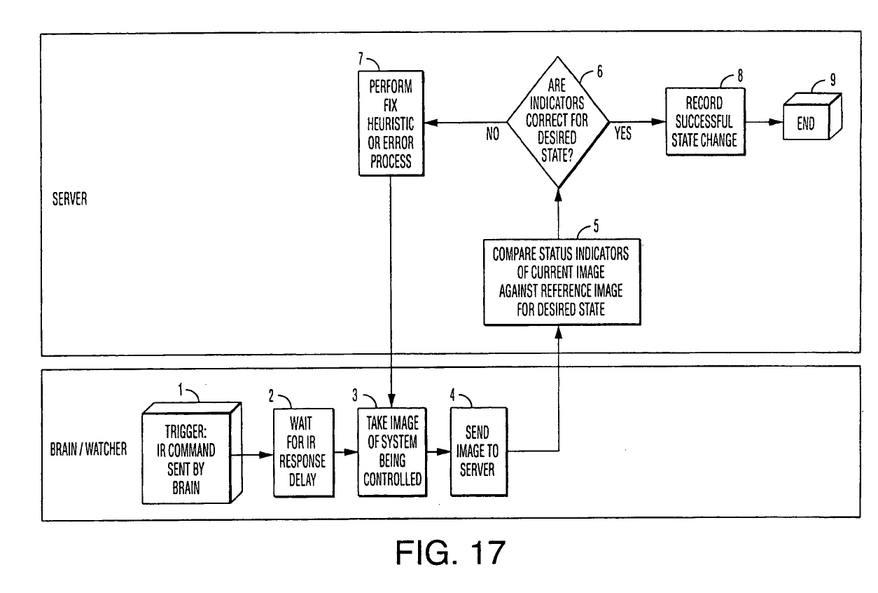

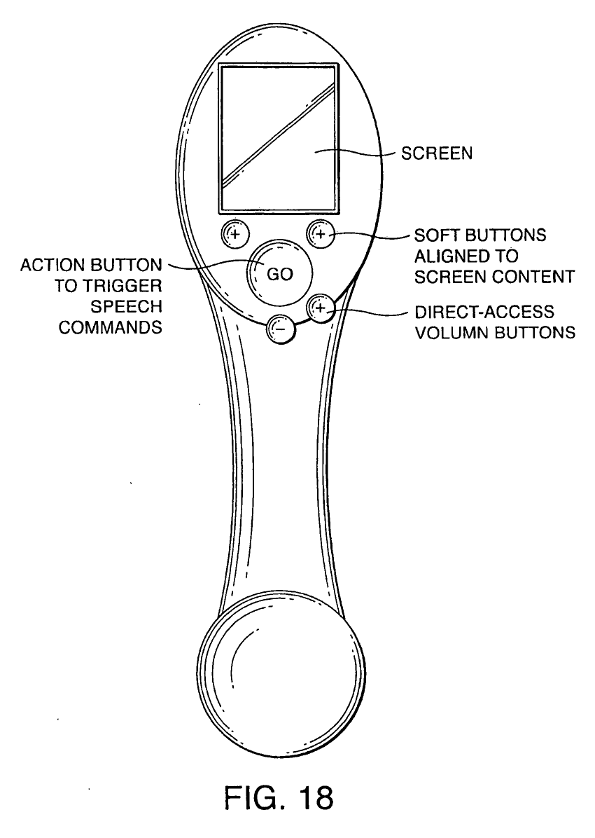

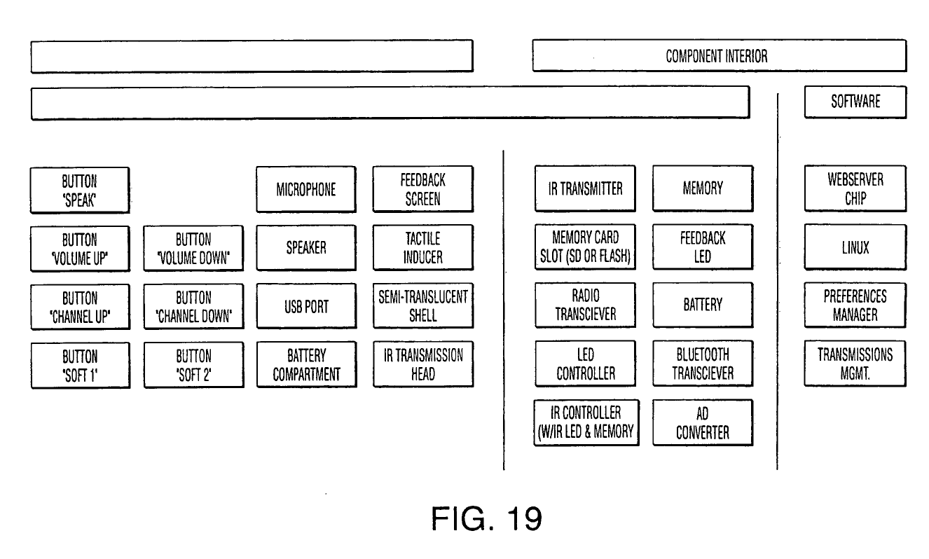

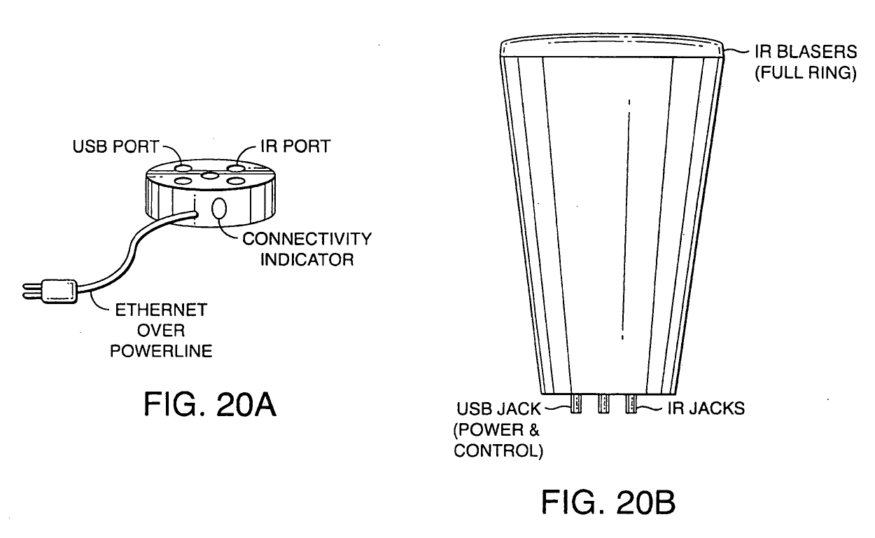

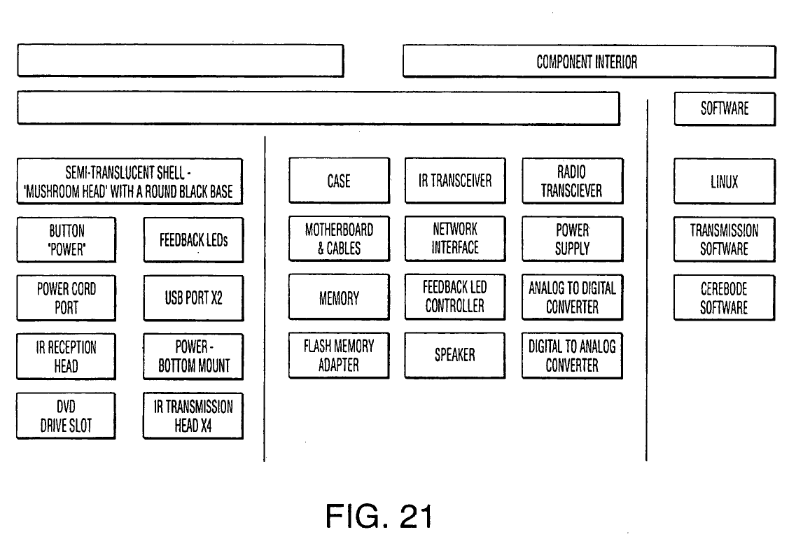

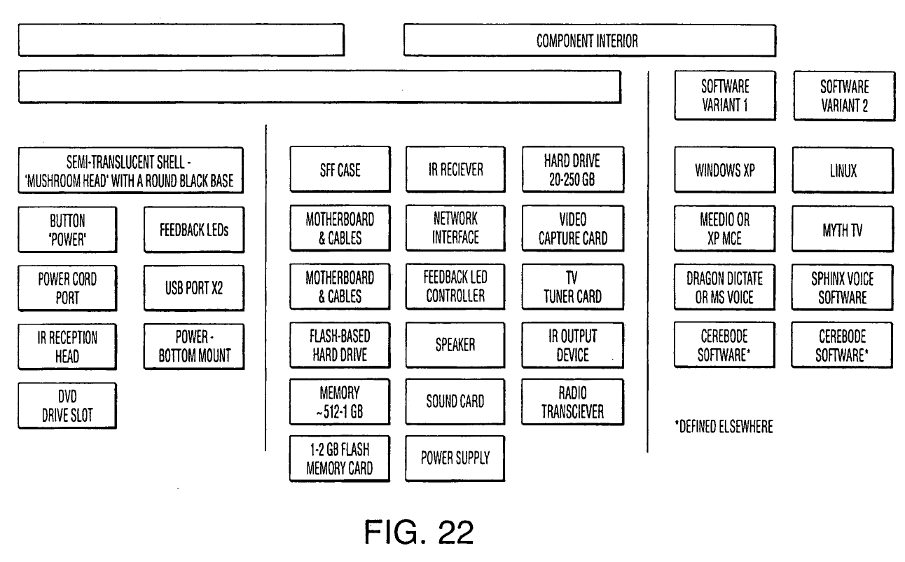

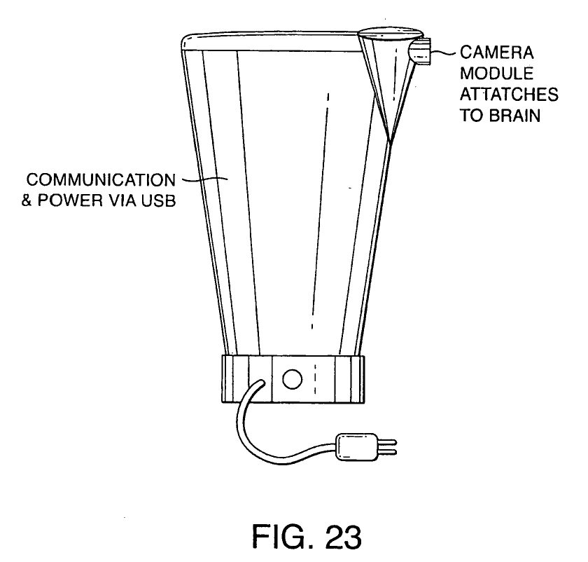

While certain figures are shown herein, one skilled in the art will appreciate that the embodiments depicted in the drawings are illustrative and that variations of those shown, as well as other embodiments described herein, may be envisioned and practiced within the scope of the present disclosure.

### DETAILED DESCRIPTION

The present disclosure provides systems and methods useful for the multimodal control of and communication with one or more systems remote from a user of the system(s). Embodiments of the present disclosure can be utilized for multimodal communication command and control of virtually any system operating remotely from a user of the system. For such command and/or control, suitable wireless techniques can be utilized by a user input device. The user input device can include but is not limited to a portable, e.g., hand-held device. Suitable wireless techniques can include but are not limited to those adapted to known RF standards (e.g., IEEE 802.11) or infrared (IR) transmission.

Exemplary embodiments and/or aspects of the present disclosure can provide dedicated controls for volume, channel, and a multiple-way navigation button (e.g., five-way) for use by the user, e.g., in guides or on-screen menus. Numerous types of systems can accordingly be controlled, for example, home entertainment and media management systems, home and/or office and/or industrial automation systems (e.g., which can include lighting, alarm, and HVAC, and the like), computer, telephony, gaming systems, and devices accessing the Internet.

As summarized previously, embodiments of a system according to the present disclosure can include three units: (i) a wireless handheld communications device (e.g., the “Wand”); (ii) a communications broker or agent (e.g., the “Brain”); and (iii) a high-power processor (e.g., the Server). In exemplary embodiments, the system can comprise a processor, repeater (or relay) for use with the user input device. The user input device can communicate instructions to the processor (which can reside in the Brain or on a separate Server). The Brain can be configured and arranged to process the instructions and in turn communicate to the system(s) being controlled (e.g., cable box, PC, Internet, etc.). Optionally, the Server can perform these tasks and communicate the appropriate actions to the Brain, which then communicates to the system(s) being controlled (e.g., cable box, PC, etc.). In exemplary embodiments, the user input/interface device can be configured as or reside in a mobile phone (e.g., cell or portable phone), landline phone PDA, or other connected mobile device. One or more servers may also be utilized in certain embodiments, and may be used in thin/thick client configurations as desired.

By moving the processing-intensive tasks (e.g. speech recognition or request interpretation) to a separate machine (e.g., thick-thin client architectures), such embodiments can provide the desired control and communications functionality at a price far lower than previously possible.

The multiple modes of interaction afforded to the user may include, but are not limited to, one or more of voice, speech, buttons, tactile response pads, graphical display, monitor or television display, and computer output device. For example, a user may ask a question of the system, which would process the request and respond by emitting an audible sound (like a tone, music, or speech), and concurrently display content on the user interface device and/or the television and/or the computer monitor. It should be understood that these listed modes are not exclusive and other modes of interaction/communication may also be utilized within the scope of the present disclosure.

An exemplary embodiment of the present disclosure, the Merlin home system, can be employed by a user to buffer the user from the technology around him or her to the degree that the user only needs to speak the result they seek and it will happen. The Wand of the Merlin system can serve as a simple, comfortable and portable means of conveying desires and receiving results. As described previously, the Brain can function as a communications broker, serving as a means for the Wand to communicate with a server (“Server) and facilitating command transmission within the home from the remote server. The Server can function as the intelligence of the system—understanding what the user needs and how to satisfy them. The Server can be constantly listening for communications from the Wand or the Brain. While these communications typically will occur over a network, they can take place locally via radio frequency, network, or other communications method. Additionally, as the Wand can be used to place a phone call we triage communications, so users can make requests while conducting a call.

In exemplary embodiments, the Wand can be configured as a handheld unit similar in size and shape to a comfortable conventional remote. Its smooth surface can cradle a screen, and a desired number of buttons. For example, the Wand can include between 1 and 5 buttons (e.g., “Action”, channel up, and channel down, volume up and volume down, and “soft buttons” which are related to topics on the device screen). The screen, buttons and voice operate in a seamless manner to make Merlin simple enough for anyone to use without training. Just pick it up, hit the action button and tell it what you want.

The Brain can serve as a charging station for the Wand, and is the communications broker between our servers and the consumers' home entertainment systems. Its flexible embedded platform is designed for easy future integration with new/supplemental systems. These units can communicate via radio frequency. The Brain can be designed to be aesthetically pleasing in a home setting. Server technology utilized by Merlin can include a consumer process automation platform directed by software that understands the user.

### Capabilities/Scope of Control in Exemplary Embodiments

Voice Control—The most comfortable human interface is voice, but poor technology and poor design have been limitations of the prior art. Voice control can be utilized in exemplary embodiments.

Home Theater:—Exemplary embodiment, e.g., the Merlin system, can be used for the communications and control of home theater systems. Consumers today are inundated with remote controls, littering our coffee tables and daunting us with hundreds of confusing buttons. Even the best “Programmable” remotes still deliver inconsistent results, require lengthy programming rituals, and need a training manual as thick as the remote, when all we really want is to watch a movie. The Merlin system can allow a user to voice this desire—literally—and can handles all the control corresponding required system control. No training and no learning of commands are required of the user. The user can simply tell Merlin what the user wants want and it happens. Embodiments of the system can operate to track the state of the controlled system(s), so Merlin remembers how the user works and can learn from his or her experiences. As examples, the Merlin system can knows a user's favorite channels, or tracks against time to remember to record the user's desired television shows.

The Internet: Systems and methods according to the present disclosure can also function to unlock the services of the Internet without requiring that a user spends hours at a keyboard. A user can command Merlin to get information, which will be delivered. Weather reports, stock listings, movie schedules, and even online shopping can be obtained by a user simply asking for it. As another example, the Merlin system can get directions and print them out on user's PC printer, or lookup product reviews and email the details to the user so you don't need to search for them. Merlin also integrates with email programs, e.g., Outlook, so that a user can review his or her schedule for the coming day or lookup a phone number without touching a PC.

As noted, aspects/embodiments of the present disclosure can be used with the Internet and can easily incorporate online content. For example, the Merlin system can be asked questions about any of a wide variety of the topics, e.g., sports scores, recipes, etc. In response, the system can research the answer and return it to the user. The response from the system can be sent to the screen display, as audio out through the built-in speakerphone, to an email, or eventually to the user's printer.

Operationally, web services and processes can be focused on primary content areas where our user base indicates they have interest. Content for a system can be provided with permission and assistance from the content providers. In some cases, attribution, such as a content provider logo or “brought to you by,” can be provided on the system screen. Examples include Amazon (e.g., small purchases, ratings, prices), Google (e.g., directions, dictionary, maps, Froogle, etc.), weather.com, Netflicks, ESPN, NYTimes (e.g., “read me the paper”), local resources pizza delivery, etc). The process for such can be interactive/iterative, with multiple steps involved if necessary.

Home/Industrial Automation: The Merlin system/method can control home and/or industrial automation hardware such as lighting and HVAC systems. The Merlin system can employs enterprise integration technology to allow easy and broad integration with a wide range of home or industrial control standards including X10, Zigbee, and Crestron, among many others.

Telephony Integration Merlin supports Voice Over IP (VOIP) call integration, so the user can use Merlin to place calls via free services like Skype or pay services like Vonage. Additional plans include Bluetooth integration enabling the use of external headsets or for location tracking within the home. Other suitable telephony standards/techniques may also be utilized within the scope of the present disclosure.

Aspects of the present disclosure can provide a user the benefit of inexpensive/free telephony capabilities (e.g., Skype or Google). For example, the Merlin system can draw contacts from outlook or from csv and enter this into listings to use for placing calls. Contact names are added to vocabulary and are recognized. Any action can be going on when a call is placed, and Merlin “listens” to manage activities during call. Ideally OSD should be usable in place of voice when call is taking place. Phone usage adds reseller revenue aspect to product, creating an annuity revenue stream.

As described previously, embodiments, e.g., Merlin system, can interact with the user in a multimodal manner, which is to say that it can understand interactions as varied as button presses and voice commands, and can respond with auditory signal through the wand, speech through the wand, visual feedback via the user's display screen on the wand, or even by sending an email to the user's inbox to be reviewed or even printed. All of this is in addition to any actions required by the user's request.

Voice input: A user need only utter the result he or she seeks and Merlin will make it happen. No user training required. Merlin recognizes various users in the house and customizes his responses to that user (e.g., a request for “dinner music” from the teenager in the house yields different results than that from the Parent). For such, the user would press the “command” button while speaking and depress the button when finished. In exemplary embodiments, five buttons are present on the device in a square pattern whose simplicity belies the advanced capabilities of the device

On-screen Display: If there are multiple answers to a question, the system/method of the present disclosure can return a picklist from which the user selects then it take the appropriate action. For example, in response to the request to play music from a particular recording artist, Merlin could return all of the works of that artist, e.g., 3 DVDs and 15 albums. The user would consequently say the name or scrolls to the appropriate selection and Merlin would then turn on the correct system and plays the selection. For some applications, an On Screen Display (OSD) can be used to indicate which system is being managed (bedroom, kitchen, entertainment System, etc)

### Overall Server Processing:

At a high level he server performs four tasks: listens for communication from the Wand or the Brain, identifies what result the user is seeking with that button press or spoken command, identifies how to achieve that result and takes appropriate action to achieve that result Server Process Description:

The Server is constantly listening for communications from the Wand or the Brain. While these communications typically will occur over a network, they can take place locally via radio frequency, network, or other communications method. As used herein, reference number indicate a relevant figure by a reference number preceding a period and a reference character or characters in that figure by numbers after the period. The Wand can be used to place a phone call, allowing we communications to be classified or triaged so users can make requests while conducting a call. When such a communication is received (1.1) the VOIP triage server (1.2) determines if the wand is currently engaged in a phone call. If a call is taking place and a button has been pressed then the Server mutes the call (1.6) and determines the nature of the button press (1.7). If no button is pressed then the call continues without interruption (1.4). In the case where no call is taking place the server immediately determines the nature of the button press (1.7). If the button press is the Action button indicating a spoken command then the audio of that command is sent to the Speech Recognition Engine (1.8), where it is converted to text (1.9,10) which is in turn passed to the Process Engine (1.11). If the button press is not a spoken command then the button ID is passed directly to the Process Engine. In the Process Engine the text of the spoken command or the button press is mapped to a specific process (1.12) (details found in the Detail: Process Engine Flow Diagram). This process is then executed (1.13) which may include interaction with the Wand (1.15)(e.g., Display a sports score on the screen of the wand), the Brain (1.16)(e.g., Send an infra-red command to a DVD player), a printer (1.17)(e.g., Print the weather for the week), or automation device (1.18)(e.g., Turn off the lights on the first floor). Once the actions prescribed by the identified process (1.12) have been executed they are recorded (1.14) and the flow is complete (1.19).

The Process Engine is engaged when the Speech Recognition is completed and the text of the spoken commands (2.1) is passed to the State & Context Manager (SCM)(2.2). Alternatively transmission of a button press to the SCM can also initiate the process. The first task of the SCM is to identify the result that is being sought by the user (2.3). The SCM relies on a range of information sources to determine what result the user is seeking and how to best achieve that result.

These information sources used to understand the user's intent include the following: (1) the current context the user is in (e.g., Last command was watching television); (2) the last known state or condition of the devices in the home (e.g., the power state of stereo components, which lights are on or off, or the current temperature set on the heating system); (3) the user's habits in the form of a detailed history of the commands a user has made in the past (recorded in (2.39); (4) any detail that the user has communicated regarding his/her desires (e.g., The user asked for the local sports scores and upon receiving baseball, basketball, and hockey scores indicated that s/he wasn't interested in baseball); (5) common habits identified in other households (e.g., 75% of users with home automation systems dim the lights when they play a movie); (6) the systems present in the user's home (e.g., the Server needs not concern itself with radio stations if the user has no radio tuner); (7) proximity of certain words to one another; (8) predefined library including both a general vocabulary and specific catalog of common phrases (e.g., “Watch the TV”, “Put on the TV”); and/or (9) a set of rules drawn from the data listed above and codified in heuristics (see Diagram 4).

If the SCM is unable to arrive at a result match with sufficient confidence an error response is generated (2.8) which is sent to the Output Feedback (2.38) for delivery to the user for screen display and/or audio feedback and troubleshooting depending on the users recorded preferences.

Following identification of the desired result (2.3) the SCM accesses the appropriate process map from within a datastore (2.4). This process map includes information about the major tasks involved in a result and how to structure the output from the system. For example, if the user says that she wants to know the weather on Thursday in New York City, then the process map includes looking up the current date and calculating the date for Thursday, identifying the appropriate process to find the weather with the Web Information Manager (WIM) (2.15-18), and identifying the appropriate output method for this process and user (she likes to see the weather icons displayed on the screen in the Wand) (2.38).

Once the process map is identified (2.4) then current device states are identified where applicable (e.g., Is the TV already on?) (2.5) and the required device states are identified (see diagram 3 below) (2.6). Finally the SCM uses the set of assets described above to determine the steps required to change the current device states to the required device states (see Diagram 3 and Diagram 4 below) (2.7).

The required actions or steps thus identified (2.7), the Process Engine then initiates the appropriate steps in order (2.7) as determined by the SCM. These steps can include sending Infra-Red commands (2.11-14)(e.g., to turn on a Television), collecting information from a web site (2.15-18)(e.g., Retrieve the weather or a recipe for Tilapia), place a phone call (2.19-21)(e.g., Call Mom), or trigger home automation (2.22-25)(e.g., Turn off all lights on the first floor).

The Infra-Red Routine takes the generic steps identified by the SCM (e.g., Television Power ON) (2.7) and makes the steps specific to the user's hardware (e.g., Sony Vega XBR300 Power ON) (2.11). The matching infra-red code representing the identified command on that particular device is then retrieved from a datastore (2.12)(e.g., IR CODE 123455141231232123). Then the IR code is sent to the brain (2.13) for retransmission to the entertainment systems. Finally the Watcher can verify that the IR command has taken effect and take corrective action if it has not (2.14). The Watcher is an optional hardware component and is described in the Watcher section of this document.

The Web Information Manager (WIM) (2.15-18) manages retrieval of information from web sites, web services, and other online content sources (e.g., Retrieval of weather data). It also facilitates submission of information to these sites (e.g., Addition of a movie to a Netflix queue). The WIM follows the steps listed below in its information processing:

Step 1) upon request from the process engine pull site access definitions and data return format from database based on defined parameters (process name and passed variables) (2.15);

### Example 1

[INPUT TO WIM FROM SCM] -[PASSED VARIABLES]
<process>weather</process> <zip>01760</zip> <duration>5</duration>
<detail>low</detail> </process>
[OUTPUT TO SITE FROM WIM] -[TABLE 1 - RECORD 1]
<URL>http://www.weather.com/search:?<zip>,<duration>,<detail></URL>

Step 2) Format request to site based on output template (in this case <URL>)(2.16)

Step 3) Retrieve resultant output from site and parse it according to template (below) (2.17)

### Example 2

[OUTPUT TO WIM FROM SITE] -[TABLE 1 - RECORD 1]
<format>header;day1high,day1low,day2high,day2low,etc;warmings;footer</format>

Step 4) Record resultant data into database (2.18)

[RECORD IN DATABASE]-[TABLE 2][RECORD 1] ID, ZIP, REQUEST DAY/TIME, REPORTED DAY1HIGH, REPORTED DAY1LOW, WARNINGS-[TABLE 2][RECORD . . . ] ID, ZIP, REQUEST DAY/TIME, REPORTED DAY . . . HIGH, REPORTED DAY . . . LOW, WARNINGS-[TABLE 2] [RECORD N] ID, ZIP, REQUEST DAY/TIME, REPORTED DAYNHIGH, REPORTED DAYNLOW, WARNINGS

The Telephony Routine places calls over the internet at the users request when provided with the name or phone number of the person being called (2.19-21). The process involves first identifying the person being called by matching the name or phone number against a database of contacts provided by the user separately (2.19,20). This database could come from a Personal Digital Assistant like a Palm Pilot, a Personal Information Manager like Microsoft Outlook, or a user's cell phone. Upon identification of the phone number of the individual to be called the call is made through the VOIP server (2.21).

The Automation Routine provides control of the user's home automation systems across a range of home automation standards and providers at the direction of the SCM (2.2). All automation devices are identified to Merlin within the initial installation and setup. The first step of the Automation Process routine to map the generic action indicated by the SCM to the appropriate device (2.22,23). For example, if the SCM indicates that the lights should be dimmed in the TV room, the lights in that room need to be identified. The command is then translated from the generic form to the specific format required by the device identified (2.24). For example if the lights to be dimmed use X10 controllers (a home automation standard), then the Dim Light at HouseCodeA ID5 command would be created. Finally this command is then sent to the Brain to be forwarded to the appropriate device (2.25).

Once the IR, Web, Telephony, or Automation routine is completed then the Process Engine can optionally trigger an Output Feedback (2.38) to the Brain, the Wand, a shared printer, or another screen or audio device. The decision to trigger such an output is made by the SCM (2.2). These outputs follow a common series of steps wherein predetermined templates designed for communication of specific types of information are pulled from their storage locations (2.26,29,32,35), populated with the appropriate information (2.27,30,33,36), and sent to the required output device (2.28,31,34,37). For example if a request was made for Merlin to lookup the weather for the following day, the results can be transmitted to the screen on the Wand as a set of estimated High and Low temperatures for the day along with an image representing the appropriate state of precipitation (sunny, windy, rain, snow, etc.)(2.26,27,28). The same information could be formatted on a page and sent as a print command to a shared printer at the user's location (2.29,30,31). This result could also be sent to the wand as audio, either in the form of automated speech through Text-To-Speech (TTS), or as a set of assembled audio clips (2.35,36,37).

Once the Output Feedback stage is complete the actions are recorded (2.39) and any delay indicated by the SCM is initiated (2.40). Such a delay may be needed to account for delays in responsiveness of a system, such as that of a Television between the initial POWER ON command and the CHANNEL UP command.

The Process Engine then determines if the set of steps commanded by the SCM have all been completed (2.41). If there are additional steps to complete the Process Engine loops back to perform the next step (2.9) and the process continues until all steps are satisfied. Once all steps have been completed the Process Engine finishes its activity (2.42).

Setup of embodiments of a system according to the present disclosure, e.g., Merlin, can involve the following steps:

CONNECT POWER: Plug the Brain's power cord into the wall and place the wand in the charging slot.

CONNECT TO THE INTERNET: If an Ethernet jack is available then connect the Brain to that jack, otherwise enter the relevant wireless details into the phone.

MEET MERLIN: Pickup the wand and follow the on-screen instructions to setup your account (including preferences like your zip code, cable provider, etc.).

TELL MERLIN ABOUT YOUR ENTERTAINMENT SYSTEM: Walk over to your entertainment system and read off your entertainment system model numbers to Merlin.

TEST SETUP: Follow the instructions on Merlin's screen to finish the setup (this will include identifying which sources are on which inputs and testing codes),

### The Visual Evaluation System (or ‘Watcher’) Description

Embodiments of the present disclosure can include a visual evaluation system (or ‘Watcher’), which can include a camera attachment for the Merlin System that allows the use of visual feedback from the entertainment systems to guide its actions and user insight. The primary use of the Watcher is to verify that commands sent to the entertainment system are received and that the proper action has been taken (diagrams 10, 11, 17).

The Watcher solves the problems that are commonly associated with conventional universal remotes by comparing the image of the components taken immediately following command transmission against “reference images” of the entertainment system recorded during the initial setup of the systems (diagram 15). These reference images capture the different visual cues components employ to illustrate changes in attributes the Merlin System wishes to track. Examples include power on or off, surround mode, input selection, channel, etc. Through the use of image comparison software and the SCM Merlin is able to identify the current state of the user's components and ensure that the result the user seeks is truly what they get (diagrams 12, 13, 14).

The Watcher can provide assistance in the setup process for the Merlin System. By providing visual feedback to the Server when the proper IR commands are sent to a component Merlin is trying to learn about the system can be setup and configured far more quickly and with less user input than previously possible. Merlin can in effect self-configure with as little information as the count and type of components the user is trying to control. For example the user could tell Merlin that s/he has a TV, a DVD player, and a cable box—just by talking to the Wand. If the user has no more information about their systems than that Merlin can take over by asking the user to verify that the camera is aimed at the components to be controlled and ensuring that they are turned off. Then the user can go to bed and in the morning Merlin will have cycled through the available options given the information the user provided and watched until it found the right commands.

While this is not time-effective it is sometimes the only option for some users for whom finding a model number is not possible. Another (less extreme) example of the Watcher's value in the setup process occurs in the common case where a component manufacturer has used a number of different IR code sets for different manufacturing runs of the same product model. For instance if the user identifies his/her television as a Sony XBR4000 that may not be enough to identify which IR codes control that system—there can be as many as 10 different sets of IR codes for that model, and only trial and error can determine which of the 10 is the right set. The Watcher can streamline this process and buffer the user from the complexity and inconvenience of such trial and error.

The Watcher can also be employed for other purposes, such as identification of TV content that has an improperly formatted aspect ratio for the user's TV. Information such as the presence of “black bars” on the sides of the TV picture allows the SCM to adjust the aspect ratio settings of the TV (if available), thus removing the much-hated black bars. The hardware component can include a digital camera that may have a motorized base for X and Y axis adjustment to reacquire the intended image. It can attach to the Brain via a USB port over which it communicates and receives power (diagram 23). Alternatively a conventional webcam can be employed for use as a Watcher. Embodiments can include one or more motors to move the field of view (FOV) of the camera to a desired location to watch the controllable or remote device/components.

Detailed Process Description for Watcher Setup Verification is shown in Diagram 16. As indicated, the Setup Verification Process is triggered during the installation process by the user submitting a new component to manage (16.1). In response the user is asked to ensure that all components are powered off (16.2) (using the Wand to make this request and subsequent confirmation). The appropriate IR codes for the new component are retrieved from the datastore (16.3) and the codes required to uniquely identify the version of this model are identified (16.4). An example would be the situation where the DVD player the user is installing has one of three different sets of IR codes that the manufacturer has shipped with the model or product category over its lifespan. In this case some codes may be similar across all specified devices and other codes must be different by definition. In this case the SCM would identify those different codes that can together uniquely identify each set of codes, such as the power and play buttons. The first of these codes is then sent to the Brain (16.5) along with a command to record the image of the system in its current state (16.6) and send that image to the Server (16.7). The Brain then sends the command to the component (16.8) and after a short delay (16.9) records another image (16.10) and sends that image to the Server (16.11). The Server then compares the two images to identify any changes (16.13) and determines if they are representative of the command specified as determined by the SCM (16.13). If the codes all produce the correct results then the code selection is recorded (16.16) and the process ends, otherwise the next set of codes is selected and process repeats until the correct codes are found (16.15). If all codes are exhausted without success (16.14) then an error process is triggered requiring further communication with the user.

Detailed Process Description for Watcher Reference Image Creation is shown in Diagram 15. The Watcher Reference Image Creation Process is triggered during the installation process by the user submitting a new component to manage (15.1). If the component has discrete on-off codes for power (15.2) then the Server sends to the Brain the command to turn off (15.3) and the Brain sends that IR command to the Component (15.4). If the component does not have discrete on-off codes for power (15.2) then a message is sent to the Wand asking the user to verify that the Component in question is turned off and confirm this through the Wand (15.7). In either case following 15.4 & 15.7 the Brain records an image of the component and identifies it as the OFF STATE reference image (15.6).

The IR commands for the component are then evaluated to determine which attributes need to be tracked by the SCM (as defined by it's device class) (15.8,9). For example any DVD player should have its power state, shuttle commands (play, pause, fast forward, rewind, and menu commands tracked). These codes are then sent in turn to the Brain (15.10) which sends them to the component (15.11), pauses for the response delay (15.12), and records an image of the components (15.13) which is sent to the Server (15.14). If the changes in the image are within a set of expectations (15.15) the image is recorded as a reference image for that particular state (15.16) and process is repeated for the next attribute to be referenced (15.17,18) until all attributes are referenced at which point the process is complete (15.17,20). This set of expectations can come from a library of images on the server, image models constructed previously representing common configurations of devices in the components device class (12,13,14), or from feedback from the user indicating that the desired state has been achieved. If the image does not change or otherwise does not meet expectations a fix heuristic or error condition is triggered (15.15,19) and the process exits (15.20).

Detailed Process Description for Watcher Command Verification is indicated Diagram 17. The Watcher Command Verification Process is triggered by the transmission of an IR code to the Brain (17.1). The Brain waits a short period to allow the component to respond to the command (17.2) then it records an image of the components (17.3) and send that image to the Server (17.4). The Server then compares the new image against the recorded reference image that correlates to the desired component state (17.5). If the indicators match (17.6) then the change of state is recorded (17.8) and the process concludes (17.9). If the indicators do not match (17.6) then the component is considered to have failed to properly change state and a separate fix heuristic or error correction is triggered (17.7).

The preceding disclosure represent illustrative embodiments of a multimodal communication command and control system and method, for use with any of a variety of systems, such as the Internet, satellite and cable television, HVAC system and the like. For the most part, the multimodal communication command and control systems and methods can be applied in any of a variety of manners for the control of any of a variety of systems or devices. Embodiments of the present disclosure can use any of a variety of storage devices and storage systems, processors and computing devices and communicate over any of a variety of networks, now known or later developed.

Accordingly, aspects/embodiments according to the present disclosure can provide one or more of the following: greater recognition performance externalities—ability to learn from others experiences in realtime and apply those learnings to the operation and performance of the system; system improves over time as it learns the users preferences, habits, etc.; significantly lower cost for its performance level than conventional home ASR solutions; using a VOIP channel for communications enables very rapid response time; far simpler usability compared to conventional systems; ability to serve as a single access device for the majority of computerizes systems in the home (entertainment systems, PCs, automation-enabled lights, drapes, HVAC; unburden the user from the tasks of finding, walking over to and selecting the appropriate light switch from amid what may be a large array of switches; and/or Integrates formerly incompatible systems enabling the user to deliver a single command that can be interpreted for a mix of home automation systems.

While the foregoing has described what are considered to be the best mode and/or other preferred embodiments, it is understood that various modifications may be made therein and that the invention or inventions may be implemented in various forms and embodiments, and that they may be applied in numerous applications, only some of which have been described herein. As used herein, the terms “includes” and “including” mean without limitation.

What is claimed is:

1. A method of controlling a controllable device, remote from a user, the method comprising:
using a local input device configured and arranged to interact via or more communication modes with a user, wherein the local input device is configured and arranged to communicate with the controllable; and
the user employing the local input device to send a command to the controllable device via the one or more communication modes.

2. A method according to claim 1, further comprising selecting a communication mode including sight.

3. A method according to claim 1, further comprising selecting a communication mode including sound.

4. A method according to claim 1, further comprising selecting a communication mode including user applied pressure.

5. The method of claim 1, delivering tactile response.

6. The method of claim 1, wherein using a local input device comprises using a handheld control device including a plurality of buttons for receiving input from the user.

7. The method of claim 1, wherein using a local input device comprises using a handheld control device including a touch screen or touch pad receiving input from the user.

8. The method of claim 1, wherein using a local input device comprises using a handheld control device including a microphone receiving input from the user.

9. The method of claim 1, further comprising recording an image of the controllable device, wherein the current state of the device can be determined from the image.

10. The method of claim 9, wherein the image is recorded in response to a command input from the user.

11. The method of claim 9, further using the image for automatic setup of the controllable device.

12. The method of claim 9, further comprising comparing the configuration state of the controllable device as shown in a reference image against that of an image recorded after a command is issued.

13. The method of claim 12, further comprising subsequently triggering a command in response.

14. The method of claim 1, wherein the user using the local input device to place a request comprises sending a command from the user to one or more processors that are configured and arranged for implementing the request.

15. The method of claim 14, wherein the one or more processors comprise one or more separate processors.

16. The method of claim 14, wherein the user's intent is understood and the appropriate steps are identified and acted upon.

17. The method of claim 16, further comprising using a state and context management system to determine the desired outcome a user is seeking.

18. The method of claim 17, further comprising selecting an optimized response to the user request to best achieve the desired outcome.

19. A method of claim 1, further comprising extracting from within an audio input that is supplied by the user, wherein the phonemes are extracted and sent immediately to a processor and the audio input is cached to be sent later to a the processor.

20. The method of claim 19, further comprising learning by the audio input from the user.

21. The method of claim 1, further comprising translating user commands between multiple automation standards, languages, or transmission methods.

22. The method of claim 1, further comprising enabling location-specific commands.

23. The method of claim 22, further comprising identifying the location of the user local to the input device.

24. The method of claim 23, further comprising triangulation between RF-enabled or IR-enabled devices and the input device.

25. A system for multimodal communications and/or control, the system comprising:
a wireless handheld communications device configured and arranged to receive input via multiple communication modes from a user and provide an output;
a first processor configured and arranged to receive and process the output of communications device, determine the result sought by a user and relay information or a command to a second processor for communication with the a remote device.

26. The system of claim 25, wherein the wireless handheld device is configured and arranged to receive an audio input from the user.

27. The system of claim 25, wherein the first processor comprises one or more remote processors configured and arranged to receive the output from the a communications device.

28. The system of claim 25, wherein the communications device is configured and arranged for telephony.

29. The system of claim 25, further comprising a visual evaluation system configured and arranged to record images of the remote device and output an image.

30. The system of claim 29, wherein the visual evaluation system comprises a camera.

31. The system of claim 30, the visual evaluation system further comprises one or more motors configured and arranged to move a field of view (FOV) of the camera to a desired location.

32. The system of claim 25, wherein the first processor further comprises an RF or IR repeater.

33. A visual evaluation system comprising:
a wireless handheld communications device configured and arranged to receive input via multiple communication modes from a user and provide an output;
a camera configured and arranged to record images of one or more remote devices; and
means for comparison of images of the one or more remote devices and trigger an action.

34. The system of claim 33, wherein the current state of the one or more remote device can be determined from the image.

35. The method of claim 34, wherein the image is recorded in response to a command input from the user.

36. The system of claim 33, further comprising one or more motors configured and arranged to move a field of view (FOV) of the camera to a desired position to monitor the one or more remote devices.

37. The system of claim 33, wherein the camera comprises a webcam.

38. A method of visual evaluation of one or more remote devices configured for operation by a user, the method comprising:
recording an image of the one or more remote devices; and
determining the current state of the one or more devices can from the image.

39. The method of claim 38, wherein the image is recorded in response to a command input from the user.

40. The method of claim 38, further using the image for automatic setup of the one or more remote devices.

41. The method of claim 38, further comprising comparing the configuration state of the one or more remote devices as shown in a reference image against that of an image recorded after a command is issued.

42. The method of claim 41, further comprising subsequently triggering a command in response.
